(19) United States
(12) Patent Application Publication
(10) Pub. No.: US 2026/0025519 A1
(43) Pub. Date: Jan. 22, 2026

(54) TEMPORAL AND SPATIAL FILTERING FOR REGION-ADAPTIVE HIERARCHICAL TRANSFORM

(71) Applicants: Douyin Vision Co., Ltd., Beijing (CN); Bytedance Inc., Los Angeles, CA (US)

(72) Inventors: Bharath Vishwanath, San Diego, CA (US); Yingzhan Xu, Beijing (CN); Kai Zhang, San Diego, CA (US); Li Zhang, San Diego, CA (US)

(21) Appl. No.: 19/330,250

(22) Filed: Sep. 16, 2025

Related U.S. Application Data
(63) Continuation of application No. PCT/CN2024/081834, filed on Mar. 15, 2024.

(30) Foreign Application Priority Data
Mar. 16, 2023 (WO) PCT/CN2023/081899

(51) Int. Cl. H04N 19/33; H04N 19/117; H04N 19/159; H04N 19/176; H04N 19/196

(52) U.S. Cl. CPC H04N 19/33; H04N 19/117; H04N 19/159; H04N 19/176; H04N 19/196

(57) ABSTRACT

A mechanism for processing video data is disclosed. The mechanism may include determining to scale an alternating current (AC) value to derive an inter prediction mode in a region-adaptive hierarchical transform (RAHT). A conversion is performed between a visual media data and a bitstream based on the inter prediction mode.

### CROSS-REFERENCE TO RELATED APPLICATIONS

This is a continuation of International Patent Application No. PCT/CN2024/081834, filed on Mar. 15, 2024, which claims the priority to and benefits of International Patent Application No. PCT/CN2023/081899, filed on Mar. 16, 2023. All the aforementioned patent applications are hereby incorporated by reference in their entireties.

### TECHNICAL FIELD

The present disclosure relates to generation, storage, and consumption of digital audio video media information in a file format.

### BACKGROUND

Digital video accounts for the largest bandwidth used on the Internet and other digital communication networks. As the number of connected user devices capable of receiving and displaying video increases, the bandwidth demand for digital video usage is likely to continue to grow.

### SUMMARY

A first aspect relates to a method for processing video data comprising: determining to scale an alternating current (AC) value to derive an inter prediction mode in region-adaptive hierarchical transform (RAHT); and performing a conversion between a visual media data and a bitstream based on the inter prediction mode.

A second aspect relates to an apparatus for processing video data comprising: a processor; and a non-transitory memory with instructions thereon, wherein the instructions upon execution by the processor, cause the processor to perform any of the preceding aspects.

A third aspect relates to non-transitory computer readable medium comprising a computer program product for use by a video coding device, the computer program product comprising computer executable instructions stored on the non-transitory computer readable medium such that when executed by a processor cause the video coding device to perform the method of any of the preceding aspects.

A fourth aspect relates to a non-transitory computer-readable recording medium storing a bitstream of a video which is generated by a method performed by a video processing apparatus, wherein the method comprises: determining to scale an alternating current (AC) value to derive an inter prediction mode in region-adaptive hierarchical transform (RAHT); and generating a bitstream based on the determining.

A fifth aspect relates to a method for storing bitstream of a video comprising: determining to scale an alternating current (AC) value to derive an inter prediction mode in region-adaptive hierarchical transform (RAHT); generating a bitstream based on the determining; and storing the bitstream in a non-transitory computer-readable recording medium.

A sixth aspect relates to a method, apparatus or system described in the present disclosure.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is an example of parent-level nodes for each sub-node of transform unit node.

FIG. 2 is a block diagram showing an example video processing system.

FIG. 3 is a block diagram of an example video processing apparatus.

FIG. 4 is a flowchart for an example method of video processing.

FIG. 5 is a block diagram that illustrates an example video coding system.

FIG. 6 is a block diagram that illustrates an example encoder.

FIG. 7 is a block diagram that illustrates an example decoder.

FIG. 8 is a schematic diagram of an example encoder.

### DETAILED DESCRIPTION

It should be understood at the outset that although an illustrative implementation of one or more embodiments are provided below, the disclosed systems and/or methods may be implemented using any number of embodiments, whether currently known or yet to be developed. The disclosure should in no way be limited to the illustrative implementations, drawings, and embodiments illustrated below, including the exemplary designs and implementations illustrated and described herein, but may be modified within the scope of the appended claims along with their full scope of equivalents.

### 1. INITIAL DISCUSSION

This disclosure is related to media file format. Specifically, this disclosure is related to point cloud coding technologies. Specifically, it is related to point cloud attribute inter prediction in region-adaptive hierarchical transform. The disclosed embodiments may be applied individually or in various combination, to any point cloud coding standard or non-standard point cloud codec, e.g., the being-developed Geometry based Point Cloud Compression (G-PCC).

### 2. ABBREVIATIONS

The following abbreviations may be used throughout this disclosure: Geometry based Point Cloud Compression (G-PCC), Moving Picture Experts Group (MPEG), three-dimensional (3D), 3D Graphics Coding Group (3DG), Call For Proposal (CFP), Video-based Point Cloud Compression (V-PCC), Region-Adaptive Hierarchical Transform (RAHT).

### 3. FURTHER DISCUSSION

MPEG is one of the main standardization groups dealing with multimedia. In 2017, the MPEG 3DG published a CFP document to start to develop point cloud coding standard[1]. The final standard will consist in two classes of solutions. V-PCC is appropriate for point sets with a relatively uniform distribution of points[2]. G-PCC is appropriate for more sparse distributions[3]. Both V-PCC and G-PCC support the coding and decoding for single point cloud and point cloud sequence.

In one point cloud, there may be geometry information and attribute information. Geometry information is used to describe the geometry locations of the data points. Attribute information is used to record some details of the data points, such as textures, normal vectors, reflections, and so on.

### 3.1 Region-Adaptive Hierarchical Transform

In G-PCC, one important point cloud attribute coding tool is RAHT. RAHT is a transform that uses the attributes associated with a node in a lower level of the octree to predict the attributes of the nodes in the next level[4]. RAHT assumes that the positions of the points are given at both the encoder and decoder. RAHT follows the octree scan backwards, from leaf nodes to root node, at each step recombining nodes into larger ones until reaching the root node. At each level of octree, the nodes are processed in the Morton order. At each decomposition, instead of grouping eight nodes at a time, RAHT does it in three steps along each dimension, (e.g., along z, then y, then x). If there are L levels in octree, RAHT takes 3L levels to traverse the tree backwards.

Let the nodes at level l be g_{l,x,y,z}, for x, y, z integers. g_{l,x,y,z} was obtained by grouping g_{l+1,2x,y,z} and g_{l+1,2x+1,y,z}, where the grouping along the first dimension was an example. RAHT only process occupied nodes. If one of the nodes in the pair is unoccupied, the other one is promoted to the next level, unprocessed, i.e., g_{l-1,x,y,z}=g_{l,2x,y,z} if the latter is the occupied node of the pair. The grouping process is repeated until reaching the root node. Note that the grouping process generates nodes at lower levels that are the result of grouping different numbers of voxels along the way. The number of nodes grouped to generate node g_{l,x,y,z} is the weight ω_{l,x,y,z} of that node.

At every grouping of two nodes, such as g_{l,2x,y,z} and g_{l,2x+1,y,z}, with their respective weights, ω_{l,2x,y,z} and ω_{l,2x+1,y,z}, RAHT applies the following transform:

$$[ \begin{matrix}{g}_{l ‐ 1 , x , y , z} \\ {h}_{l - 1 , x , y , z}\end{matrix} ] = {T}_{{ω}_{1} {ω}_{2}} [ \begin{matrix}{g}_{l , 2 x , y , z} \\ {h}_{l , 2 x + 1 , y , z}\end{matrix} ] ,$$

Where ω₁=ω_{l,2x,y,z} and ω₂=ω_{l,2x+1,y,z} and

$${T}_{{ω}_{1} {ω}_{2}} = \frac{1}{\sqrt{{ω}_{1} + {ω}_{2}}} [ \begin{matrix}\sqrt{{ω}_{1}} & \sqrt{{ω}_{2}} \\ - \sqrt{{ω}_{2}} & \sqrt{{ω}_{1}}\end{matrix} ] .$$

Note that the transform matrix changes at all times, adapting to the weights, i.e., adapting to the number of leaf nodes that each g_{l,x,y,z} actually represents. The quantities g_{l,x,y,z} are used to group and compose further nodes at a lower level. h_{l,x,y,z} are the actual high-pass coefficients generated by the transform to be encoded and transmitted. Furthermore, weights accumulate for the level above. In the above example,

$${ω}_{l - 1 , 2 , y , z} = {ω}_{l , 2 x , y , z} + {ω}_{l , 2 x + 1 , y , z}$$

In the last stage, the tree root, the remaining two voxels g_{1,0,0,0} and g_{1,1,0,0} are transformed into the final two coefficients as:

$$[ \begin{matrix}{g}_{DC} \\ {h}_{0 , 0 , 0 , 0}\end{matrix} ] = {T}_{{ω}_{1 , 0 , 0 , 0} {ω}_{1 , 1 , 0 , 0}} [ \begin{matrix}{g}_{1 , 0 , 0 , 0} \\ {g}_{1 , 1 , 0 , 0}\end{matrix} ]$$

Where g_{DC}=g_{0,0,0,0}.

In G-PCC, for RAHT, the fundamental processing unit is a 2×2×2 node, referred to as an RAHT node with 2 samples in the x, y, and z directions. RAHT decomposes 2×2×2 to get transform coefficients {LLL, LLH, LHL, HLL, LHH, HLH, HHL, HHH}, where L refers to a low frequency coefficient in a direction, and H refers to a high frequency coefficient in a direction. Accordingly, LHL corresponds to a high frequency coefficient in the y direction, and low frequency coefficients in the x and z directions. Similarly, LLH corresponds to a high frequency coefficient in the z direction, and low frequency coefficients in the x and y directions. After the decomposition, the LLL coefficients (i.e., the DC coefficients) from one stage of transform are collected and processed in the next stage of transform.

### 3.2 Upsampled Transform Domain Prediction in RAHT

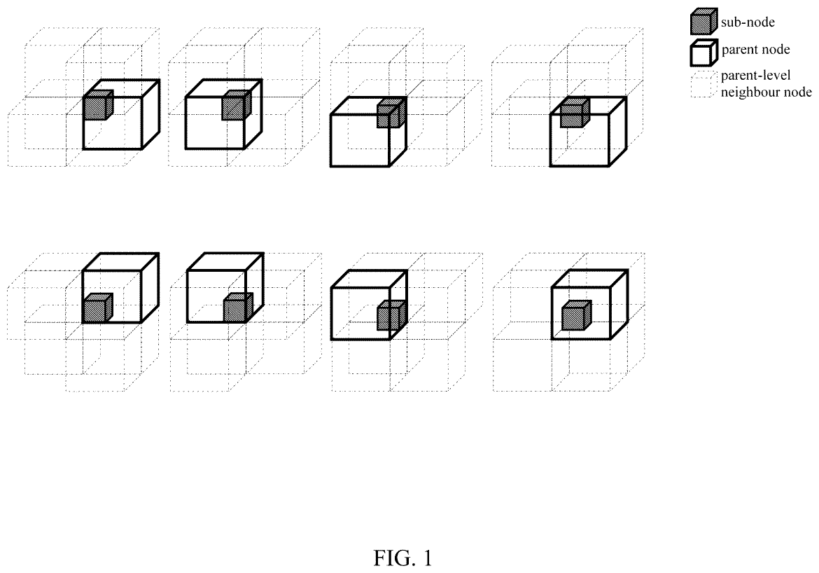

FIG. 1 is an example of parent-level nodes for each sub-node of transform unit node.

The transform domain prediction is introduced to improve coding efficiency on RAHT[5]. It is formed of two parts.

First, the RAHT tree traversal is changed to be descent-based from the previous ascent-based approach, i.e., a tree of attribute and weight sums is constructed and then RAHT is performed from the root of the tree to the leaves for both the encoder and the decoder. The transform is also performed in octree node transform unit that has 2×2×2 sub-nodes. Within the node, the encoder transform order is from leaves to the root.

Second, for each sub-node of transform unit, a corresponding predicted sub-node is produced by upsampling the previous transform level. Actually, only sub-node that contains at last one point will produce a corresponding predicted sub-node. The transform unit that contains 2×2×2 predicted sub-nodes is transformed and subtracted from the transformed attributes at the encoder side.

Each sub-node of transform unit node is predicted by 7 parent-level nodes where 3 coline parent-level neighbor nodes, 3 coplane parent-level neighbor nodes and 1 parent node. Coplane and coline neighbors are the neighbors that share a face and an edge with current transform unit node, respectively. FIG. 1 shows seven parent-level nodes for each sub-node of transform unit node.

The attribute aᵤₚ of each sub-node is predicted depending on the distance between the sub-node and its parent-level node as follows.

$${a}_{up} = \sum {ω}_{k} {a}_{k} / \sum {ω}_{k}$$

aₖ is the attribute of its one parent-level node and ωₖ is weight depending on the distance. In G-PCC, ωₚₐᵣₑₙₜ:ω_{coplane}:ω_{coline}=4:2:1.

For alternating current (AC) coefficient, the prediction residual will be signalled.

For direct current (DC) coefficient, the coefficients are inherited from the previous level, which means that the DC coefficient is signalled without prediction. It should be noted that a DC coefficient is a coefficient with zero frequency and AC coefficients are coefficients with non-zero frequencies.

### 3.3 Attribute Inter Prediction in RAHT

The attribute inter prediction in RAHT is employed in some examples [6]. For example, inter-prediction may be applied to DC and AC coefficients in RAHT. The same octree decomposition is performed on the current frame and the reference frame.

For the top L layers (e.g., specified in the bitstream), the same scan of the octree is performed on the two frames. Before performing the octree scan backwards, a point-to-point matching process may be performed to ensure that the node of the reference frame can establish a corresponding one-to-one relationship with the node of the current frame. For each point in the reference frame, it will be matched to one point in the current frame in an “upper matching” method. The Morton value of the matched point is the smallest Morton value greater than the Morton value of the current point.

For DC coefficients, the residual between the DC coefficient for the root node of the current frame and the DC coefficient for the root node of the reference frame is calculated as:

$${DC}_{residual} = {DC}_{current} - {DC}_{reference}$$

The DC_{residual} is signalled to the decoder in place of DC_{current}.

For each node in the top L layers, the average attribute of the node in the same octree location in the reference frame is calculated as Attr_{predicted_inter} and the corresponding AC coefficients are calculated as AC_{predicted_inter}.

For AC coefficients, the prediction residual is signalled as:

$${AC}_{residual} = {AC}_{current} - {AC}_{predicted}$$

$${AC}_{predicted} = {AC}_{predicted\_inter} ? {AC}_{predicted\_inter} : {AC}_{predicted\_intra}$$

If the AC_{predicted_inter} is equal to zero, the AC_{predicted_intra} is applied as the original transform domain prediction.

### 4. TECHNICAL PROBLEMS ADDRESSED BY DISCLOSED EMBODIMENTS

An example design for point cloud attribute inter prediction in region-adaptive hierarchical transform (RAHT) has the following problems:

In the example design, DC and AC prediction from the reference frame or from the parent nodes of the current frame are simply copied. This assumes a correlation coefficient of 1, which is rarely true for point-clouds, especially for the inter-prediction. Thus, the predictions should be filtered/scaled appropriately to obtain improved prediction.

### 5. A LISTING OF SOLUTIONS AND EMBODIMENTS

To address at least some of the above problems and some other problems not mentioned, methods as summarized below are disclosed. The items should be considered as examples to explain the general concepts and should not be interpreted in a narrow way. Furthermore, these embodiments can be applied individually or combined in any manner.
1) It is proposed to scale the reference AC value to derive the inter-prediction in RAHT. The scaled prediction is given by:

$${AC}_{predictedinter} = α * {AC}_{reference}$$

a. In one example, AC_{reference} may be in the sum of attribute space domain when inter prediction is done in the attribute space domain.
b. Alternatively, AC_{reference} may be in RAHT transform domain when inter prediction is done in the transform domain.
c. In one example, AC_{reference} may be derived from node(s) in the reference frame.
   i. In one example, ACreference may be derived from a corresponding node in the reference frame.
   ii. In one example, ACreference may be derived from a corresponding node after motion compensation.
   iii. In one example, ACreference may be derived by interpolating at a position in the reference frame.
d. In one example, the scaling may be applied to a subset of RAHT layers.
   i. In one example, the subset of layers may depend on the layers that apply inter-prediction.
   ii. In one example, scaling may be applied to the first N RAHT layers.
      1. In one example, N may be a pre-defined value.
      2. In one example, N may be derived at the encoder/decoder.
      3. In one example, N may be signalled to the decoder.
   iii. In one example, scaling may be applied to the last N RAHT layers.
      1. In one example, N may be a pre-defined value.
      2. In one example, N may be derived at the encoder/decoder.
      3. In one example, N may be signalled to the decoder.
   iv. In one example, the layers may be a subset of RAHT layers.
      1. In one example, additional flags may be signalled per layer that use inter-prediction to indicate the usage of scaling factor(s).
      2. In one example, the subset may be pre-defined.
   v. In one example, the different subsets may be used depending on, for example:
      1. An attribute channel; and/or
      2. A frame or group of pictures, quantization parameters (QPs), etc.
e. In one example, the scaling may be enabled only for some regions of point cloud.
   i. In one example, scaling could be enabled for only regions with motion greater than or less than a threshold.
   ii. In one example, the threshold may be pre-defined.
   iii. In one example, the threshold may be signalled to the decoder.
f. In one example, the scaling may be enabled/disabled for inter-prediction based on an analysis of a DC value of the current node and a DC value of the reference node.
   i. For example, the scaling may be enabled only if the ratio of the DC value of the current node to the DC value of the reference node is greater than a threshold or less than a threshold.
   ii. In one example, the threshold may be pre-defined.
   iii. In one example, the threshold may be signalled to the decoder.
g. In one example, the scaling value (α) may be different for different scenarios.
   i. In one example, α may be different for different RAHT layers.
   ii. In one example, α or set of αs may further be different for different attribute channels.
   iii. In one example, α or set of αs may further be different for different QPs.
   iv. In one example, α or set of αs may further be different for different frames or group of pictures.
   v. In one example, within an octree layer, a subset of nodes may share a same scaling factor or a same set of scaling factors.
h. In one example, scaling may be applied before RAHT transform, i.e., in the sum of attribute space.
i. In one example, scaling may be applied after the RAHT transform.
   i. In one example, α may further be different for different sub-bands.
   ii. In one example, α may further be different for different frequencies in a RAHT layer, which are indicated by {LLH, LHL, HLL, HHL, HLH, LHH, HHH}.
      1. For example, LLH, LHL, HLL, HHL, HLH, LHH, HHH may have different as respectively.
      2. For example, a subset such as {LLH, LHL, HLL} may share a value of α.
j. In one example, α may be predictively coded, i.e., the difference α_{diff}=α−α_{pred} may be sent to the decoder.
   i. In one example, α_{pred} could be a fixed value such as unity.
   ii. In one example, α_{pred} could be a scaling factor previously sent to the decoder, such as for the previous region/previous layer/same layer in previous frame etc.
   iii. In one example, α_{diff} could be further quantized and sent to the decoder. The quantizer may be an inbuilt quantizer used in G-PCC or a specialized quantizer designed specifically for α_{diff}.
k. In one example, the determination of a may be as follows,
   i. In one example, a fixed α or a fixed set of αs may be used by the encoder and the decoder.
   ii. In one example, α may be determined by encoder and conveyed to the decoder.
      1. For example, the encoder may estimate the α based on least square minimization or other criteria. The estimated value may be quantized and sent to the decoder. The estimation may be per octree layer/per-region etc.
      2. For example, the encoder may select α from the set of pre-determined α values and send the best factor to the decoder.
   iii. In one example, α may be estimated both by encoder and decoder based the already reconstructed neighbors.
      1. For example, α may be estimated, by performing least squares estimation utilizing reconstructed neighbors and their reference samples as the training samples.
      2. For example, α may be a linear combination of the scaling factors of the last K coded RAHT nodes or K nearest neighboring nodes.
   iv. In one example, α may be derived from geometric differences between a current node and a reference node.
      1. For example, α may decay exponentially as the geometric difference.
   v. In one example, if the reference frame is also inter-predicted, the values of α may be inherited from the reference frame.
   vi. In one example, the values of α may be inherited from the spatial neighbors.
   vii. In one example, the DC value of the parent and the DC value of the reference node may be utilized to determine the scaling for AC prediction.
      1. For example, the α for the AC prediction maybe the ratio of the parent DC value and reference DC value.
l. In one example, the usage of the method may depend on the global motion or local motion of the current frame.
   i. In one example, the scaled prediction may be used only when the motion is greater than a certain threshold.
   ii. In one example, different sets of a may be used depending on motion being less than or greater than a certain threshold.
   iii. In one example, the above thresholds may be pre-defined or signalled to the decoder.
   iv. For example, the number of layers that employ scaled prediction may depend on the global motion.
      1. For example, the number of layers may be more when the global motion is high.
m. In one example, different regions of point clouds may use different scaling factor(s).
   i. For example, regions could be defined based on criterions such as motion, texture, etc.
n. In case inter-prediction involves multiple (such as F) reference frames, the model may be appropriately modified as:

$${AC}_{predictedinter} = {α}_{1} * {AC}_{ref 1} + {α}_{2} * {AC}_{ref 2} + … + {α}_{F} * {AC}_{refF}$$

i. In one example, the determination and usage of these factors may follow similar rationale as prediction with single reference frame.
2) In one example, it is proposed to scale the intra-predicted samples in the RAHT layers that use AC inter-prediction.
   i. Determination and usage of the scaling factor may depend on similar factors as inter prediction.
   ii. In one example, the intra-predicted samples may have different scaling factors with the inter-predicted samples.
3) In one example, it is proposed to scale the DC value when the DC value is not inherited from the parent. The scaled prediction is given by:

$${DC}_{predictedinter} = α * {DC}_{reference}$$

i. Determination and usage of the scaling factor may depend on similar factors as AC scaled prediction.
4) Whether to and/or how to apply a method disclosed above may be signalled from encoder to decoder in a bitstream/frame/tile/slice/octree/etc.
5) Whether to and/or how to apply the disclosed methods above may be dependent on coded information, such as dimensions, color format, color component, slice/picture type.

### 6. REFERENCES

[1] MPEG 3DG and Requirements, “Call for Proposals for Point Cloud Compression V2”, ISO/IEC JTC1/SC29 WG11 N16763.
[2] ISO/IEC JTC 1/SC 29/WG 07, “Information technology—Coded Representation of Immersive Media—Part 5: Visual Volumetric Video-based Coding (V3C) and Video-based Point Cloud Compression (V-PCC)”, ISO/IEC 23090-5.
[3] ISO/IEC JTC 1/SC 29/WG 11, “Information technology—MPEG-I (Coded Representation of Immersive Media)—Part 9: Geometry-based Point Cloud Compression”, ISO/IEC 23090-9:2020(E).
[4] Ricardo L. De Queiroz and Philip A. Chou, “Compression of 3D Point Clouds Using a Region-Adaptive Hierarchical Transform”, IEEE Transactions on Image Processing.
[5] S. Lasserre, D. Flynn, “On an improvement of RAHT to exploit attribute correlation”, ISO/IEC JTC1/SC29/WG11 M47378.
[6] Y.-Z. Xu, W. Wang, K. Zhang, L. Zhang, [G-PCC][EE13.2 related][New proposal] Inter-Prediction for RAHT Attribute Coding, ISO/IEC JTC1/SC29/WG7 m61083, October 2022.

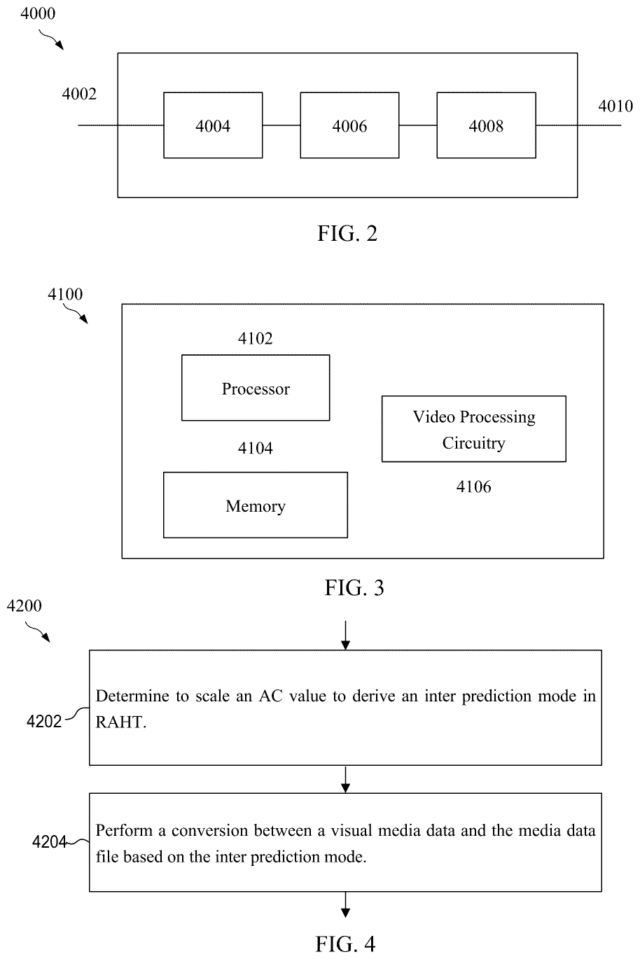

FIG. 2 is a block diagram showing an example video processing system 4000 in which various embodiments disclosed herein may be implemented. Various implementations may include some or all of the components of the system 4000. The system 4000 may include input 4002 for receiving video content. The video content may be received in a raw or uncompressed format, e.g., 8- or 10-bit multi-component pixel values, or may be in a compressed or encoded format. The input 4002 may represent a network interface, a peripheral bus interface, or a storage interface. Examples of network interface include wired interfaces such as Ethernet, passive optical network (PON), etc. and wireless interfaces such as Wi-Fi or cellular interfaces.

The system 4000 may include a coding component 4004 that may implement the various coding or encoding methods described in the present disclosure. The coding component 4004 may reduce the average bitrate of video from the input 4002 to the output of the coding component 4004 to produce a coded representation of the video. The coding techniques are therefore sometimes called video compression or video transcoding techniques. The output of the coding component 4004 may be either stored, or transmitted via a communication connected, as represented by the component 4006. The stored or communicated bitstream (or coded) representation of the video received at the input 4002 may be used by a component 4008 for generating pixel values or displayable video that is sent to a display interface 4010. The process of generating user-viewable video from the bitstream representation is sometimes called video decompression. Furthermore, while certain video processing operations are referred to as “coding” operations or tools, it will be appreciated that the coding tools or operations are used at an encoder and corresponding decoding tools or operations that reverse the results of the coding will be performed by a decoder.

Examples of a peripheral bus interface or a display interface may include universal serial bus (USB) or high definition multimedia interface (HDMI) or DisplayPort, and so on. Examples of storage interfaces include serial advanced technology attachment (SATA), peripheral component interconnect (PCI), integrated drive electronics (IDE) interface, and the like. The embodiments described in the present disclosure may be embodied in various electronic devices such as mobile phones, laptops, smartphones or other devices that are capable of performing digital data processing and/or video display.

FIG. 3 is a block diagram of an example video processing apparatus 4100. The apparatus 4100 may be used to implement one or more of the methods described herein. The apparatus 4100 may be embodied in a smartphone, tablet, computer, Internet of Things (IoT) receiver, and so on. The apparatus 4100 may include one or more processors 4102, one or more memories 4104 and video processing circuitry 4106. The processor(s) 4102 may be configured to implement one or more methods described in the present disclosure. The memory (memories) 4104 may be used for storing data and code used for implementing the methods and embodiments described herein. The video processing circuitry 4106 may be used to implement, in hardware circuitry, some embodiments described in the present disclosure. In some embodiments, the video processing circuitry 4106 may be at least partly included in the processor 4102, e.g., a graphics co-processor.

FIG. 4 is a flowchart for an example method 4200 of video processing. The method 4200 determines to scale an alternating current (AC) value to derive an inter prediction mode in region-adaptive hierarchical transform (RAHT) at step 4202. A conversion is performed between a visual media data and a visual media data file based on the inter prediction mode at step 4204. The conversion of step 4204 may include encoding at an encoder or decoding at a decoder, depending on the example.

It should be noted that the method 4200 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4200. Further, the method 4200 can be performed by a non-transitory computer readable medium comprising a computer program product for use by a video coding device. The computer program product comprises computer executable instructions stored on the non-transitory computer readable medium such that when executed by a processor cause the video coding device to perform the method 4200.

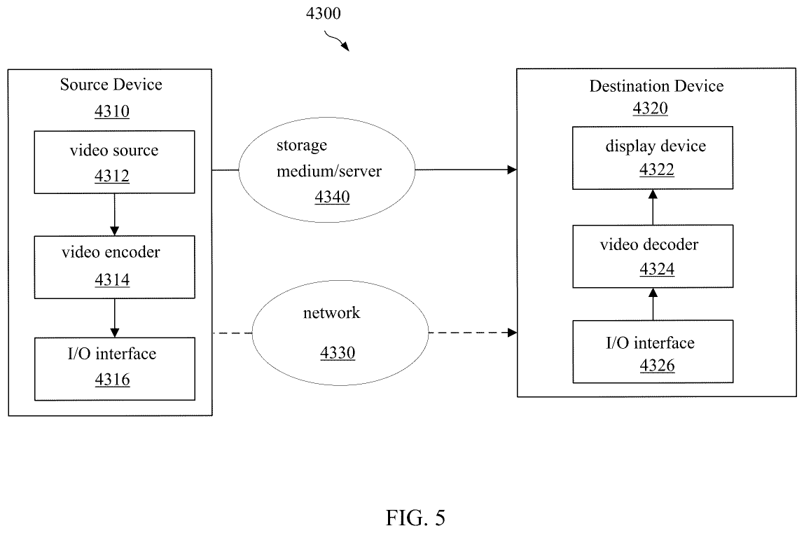

FIG. 5 is a block diagram that illustrates an example video coding system 4300 that may utilize the embodiments of this disclosure. The video coding system 4300 may include a source device 4310 and a destination device 4320. Source device 4310 generates encoded video data which may be referred to as a video encoding device. Destination device 4320 may decode the encoded video data generated by source device 4310 which may be referred to as a video decoding device.

Source device 4310 may include a video source 4312, a video encoder 4314, and an input/output (I/O) interface 4316. Video source 4312 may include a source such as a video capture device, an interface to receive video data from a video content provider, and/or a computer graphics system for generating video data, or a combination of such sources. The video data may comprise one or more pictures. Video encoder 4314 encodes the video data from video source 4312 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. I/O interface 4316 may include a modulator/demodulator (modem) and/or a transmitter. The encoded video data may be transmitted directly to destination device 4320 via I/O interface 4316 through network 4330. The encoded video data may also be stored onto a storage medium/server 4340 for access by destination device 4320.

Destination device 4320 may include an I/O interface 4326, a video decoder 4324, and a display device 4322. I/O interface 4326 may include a receiver and/or a modem. I/O interface 4326 may acquire encoded video data from the source device 4310 or the storage medium/server 4340. Video decoder 4324 may decode the encoded video data. Display device 4322 may display the decoded video data to a user. Display device 4322 may be integrated with the destination device 4320, or may be external to destination device 4320, which can be configured to interface with an external display device.

Video encoder 4314 and video decoder 4324 may operate according to a video compression standard, such as the High Efficiency Video Coding (HEVC) standard, Versatile Video Coding (VVC) standard, and other current and/or further standards.

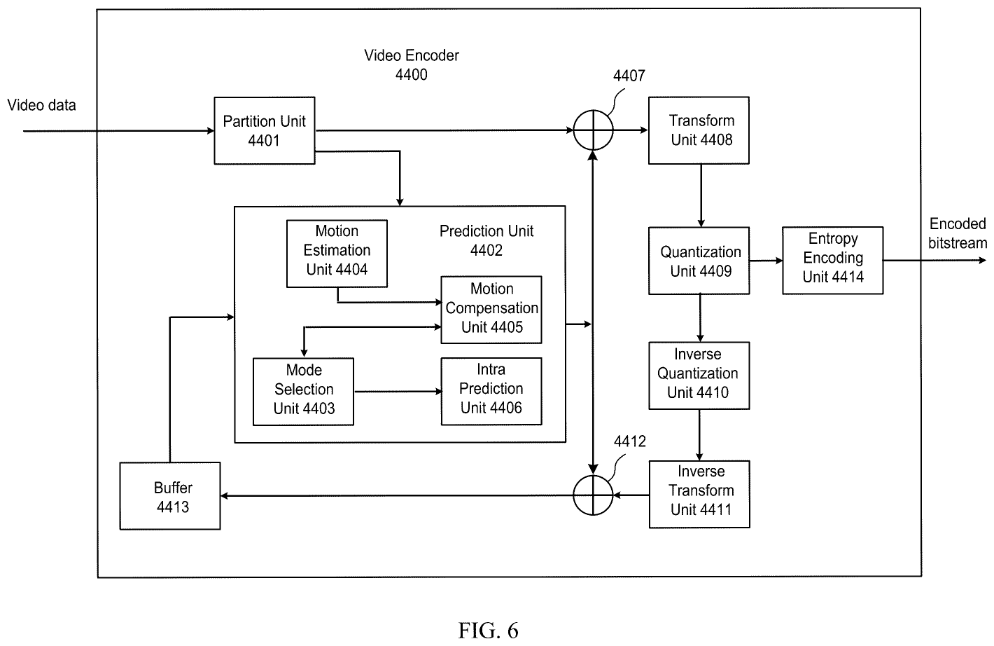

FIG. 6 is a block diagram illustrating an example of video encoder 4400, which may be video encoder 4314 in the system 4300 illustrated in FIG. 5. Video encoder 4400 may be configured to perform any or all of the embodiments of this disclosure. The video encoder 4400 includes a plurality of functional components. The embodiments described in this disclosure may be shared among the various components of video encoder 4400. In some examples, a processor may be configured to perform any or all of the embodiments described in this disclosure.

The functional components of video encoder 4400 may include a partition unit 4401; a prediction unit 4402, which may include a mode select unit 4403, a motion estimation unit 4404, a motion compensation unit 4405, and an intra prediction unit 4406; a residual generation unit 4407; a transform processing unit 4408; a quantization unit 4409; an inverse quantization unit 4410; an inverse transform unit 4411; a reconstruction unit 4412; a buffer 4413; and an entropy encoding unit 4414.

In other examples, video encoder 4400 may include more, fewer, or different functional components. In an example, prediction unit 4402 may include an intra block copy (IBC) unit. The IBC unit may perform prediction in an IBC mode in which at least one reference picture is a picture where the current video block is located.

Furthermore, some components, such as motion estimation unit 4404 and motion compensation unit 4405 may be highly integrated, but are represented in the example of video encoder 4400 separately for purposes of explanation.

Partition unit 4401 may partition a picture into one or more video blocks. Video encoder 4400 and video decoder 4500 may support various video block sizes.

Mode select unit 4403 may select one of the coding modes, intra or inter, e.g., based on error results, and provide the resulting intra or inter coded block to a residual generation unit 4407 to generate residual block data and to a reconstruction unit 4412 to reconstruct the encoded block for use as a reference picture. In some examples, mode select unit 4403 may select a combination of intra and inter prediction (CIIP) mode in which the prediction is based on an inter prediction signal and an intra prediction signal. Mode select unit 4403 may also select a resolution for a motion vector (e.g., a sub-pixel or integer pixel precision) for the block in the case of inter prediction.

To perform inter prediction on a current video block, motion estimation unit 4404 may generate motion information for the current video block by comparing one or more reference frames from buffer 4413 to the current video block. Motion compensation unit 4405 may determine a predicted video block for the current video block based on the motion information and decoded samples of pictures from buffer 4413 other than the picture associated with the current video block.

Motion estimation unit 4404 and motion compensation unit 4405 may perform different operations for a current video block, for example, depending on whether the current video block is in an I slice, a P slice, or a B slice.

In some examples, motion estimation unit 4404 may perform uni-directional prediction for the current video block, and motion estimation unit 4404 may search reference pictures of list 0 or list 1 for a reference video block for the current video block. Motion estimation unit 4404 may then generate a reference index that indicates the reference picture in list 0 or list 1 that contains the reference video block and a motion vector that indicates a spatial displacement between the current video block and the reference video block. Motion estimation unit 4404 may output the reference index, a prediction direction indicator, and the motion vector as the motion information of the current video block. Motion compensation unit 4405 may generate the predicted video block of the current block based on the reference video block indicated by the motion information of the current video block.

In other examples, motion estimation unit 4404 may perform bi-directional prediction for the current video block, motion estimation unit 4404 may search the reference pictures in list 0 for a reference video block for the current video block and may also search the reference pictures in list 1 for another reference video block for the current video block. Motion estimation unit 4404 may then generate reference indexes that indicate the reference pictures in list 0 and list 1 containing the reference video blocks and motion vectors that indicate spatial displacements between the reference video blocks and the current video block. Motion estimation unit 4404 may output the reference indexes and the motion vectors of the current video block as the motion information of the current video block. Motion compensation unit 4405 may generate the predicted video block of the current video block based on the reference video blocks indicated by the motion information of the current video block.

In some examples, motion estimation unit 4404 may output a full set of motion information for decoding processing of a decoder. In some examples, motion estimation unit 4404 may not output a full set of motion information for the current video. Rather, motion estimation unit 4404 may signal the motion information of the current video block with reference to the motion information of another video block. For example, motion estimation unit 4404 may determine that the motion information of the current video block is sufficiently similar to the motion information of a neighboring video block.

In one example, motion estimation unit 4404 may indicate, in a syntax structure associated with the current video block, a value that indicates to the video decoder 4500 that the current video block has the same motion information as another video block.

In another example, motion estimation unit 4404 may identify, in a syntax structure associated with the current video block, another video block and a motion vector difference (MVD). The motion vector difference indicates a difference between the motion vector of the current video block and the motion vector of the indicated video block. The video decoder 4500 may use the motion vector of the indicated video block and the motion vector difference to determine the motion vector of the current video block.

As discussed above, video encoder 4400 may predictively signal the motion vector. Two examples of predictive signalling techniques that may be implemented by video encoder 4400 include advanced motion vector prediction (AMVP) and merge mode signalling.

Intra prediction unit 4406 may perform intra prediction on the current video block. When intra prediction unit 4406 performs intra prediction on the current video block, intra prediction unit 4406 may generate prediction data for the current video block based on decoded samples of other video blocks in the same picture. The prediction data for the current video block may include a predicted video block and various syntax elements.

Residual generation unit 4407 may generate residual data for the current video block by subtracting the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and residual generation unit 4407 may not perform the subtracting operation.

Transform processing unit 4408 may generate one or more transform coefficient video blocks for the current video block by applying one or more transforms to a residual video block associated with the current video block.

After transform processing unit 4408 generates a transform coefficient video block associated with the current video block, quantization unit 4409 may quantize the transform coefficient video block associated with the current video block based on one or more quantization parameter (QP) values associated with the current video block.

Inverse quantization unit 4410 and inverse transform unit 4411 may apply inverse quantization and inverse transforms to the transform coefficient video block, respectively, to reconstruct a residual video block from the transform coefficient video block. Reconstruction unit 4412 may add the reconstructed residual video block to corresponding samples from one or more predicted video blocks generated by the prediction unit 4402 to produce a reconstructed video block associated with the current block for storage in the buffer 4413.

After reconstruction unit 4412 reconstructs the video block, the loop filtering operation may be performed to reduce video blocking artifacts in the video block.

Entropy encoding unit 4414 may receive data from other functional components of the video encoder 4400. When entropy encoding unit 4414 receives the data, entropy encoding unit 4414 may perform one or more entropy encoding operations to generate entropy encoded data and output a bitstream that includes the entropy encoded data.

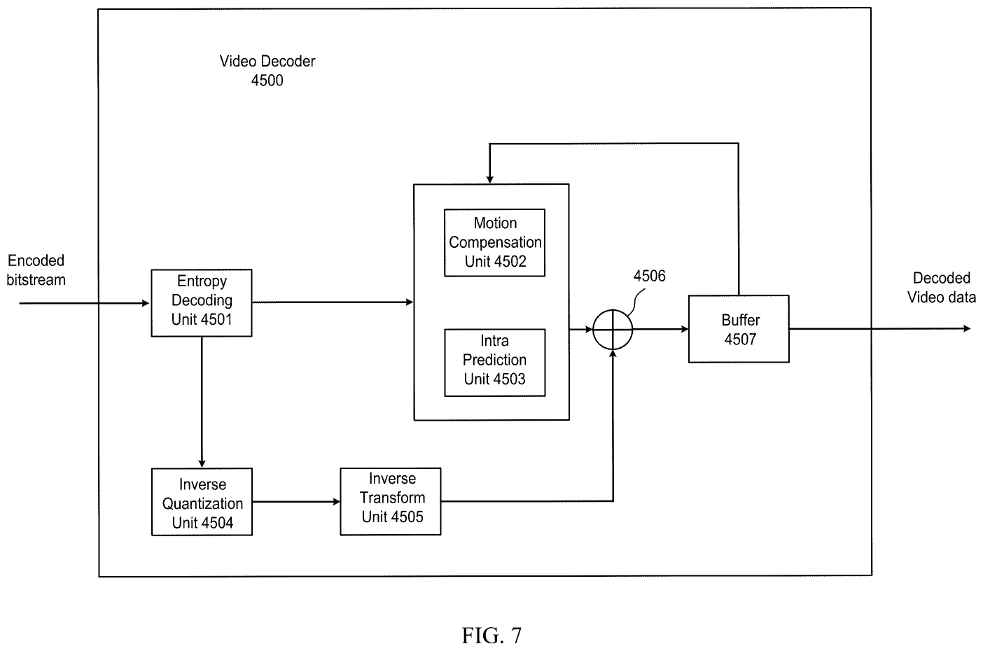

FIG. 7 is a block diagram illustrating an example of video decoder 4500 which may be video decoder 4324 in the system 4300 illustrated in FIG. 5. The video decoder 4500 may be configured to perform any or all of the embodiments of this disclosure. In the example shown, the video decoder 4500 includes a plurality of functional components. The embodiments described in this disclosure may be shared among the various components of the video decoder 4500. In some examples, a processor may be configured to perform any or all of the embodiments described in this disclosure.

In the example shown, video decoder 4500 includes an entropy decoding unit 4501, a motion compensation unit 4502, an intra prediction unit 4503, an inverse quantization unit 4504, an inverse transformation unit 4505, a reconstruction unit 4506, and a buffer 4507. Video decoder 4500 may, in some examples, perform a decoding pass generally reciprocal to the encoding pass described with respect to video encoder 4400.

Entropy decoding unit 4501 may retrieve an encoded bitstream. The encoded bitstream may include entropy coded video data (e.g., encoded blocks of video data). Entropy decoding unit 4501 may decode the entropy coded video data, and from the entropy decoded video data, motion compensation unit 4502 may determine motion information including motion vectors, motion vector precision, reference picture list indexes, and other motion information. Motion compensation unit 4502 may, for example, determine such information by performing the AMVP and merge mode.

Motion compensation unit 4502 may produce motion compensated blocks, possibly performing interpolation based on interpolation filters. Identifiers for interpolation filters to be used with sub-pixel precision may be included in the syntax elements.

Motion compensation unit 4502 may use interpolation filters as used by video encoder 4400 during encoding of the video block to calculate interpolated values for sub-integer pixels of a reference block. Motion compensation unit 4502 may determine the interpolation filters used by video encoder 4400 according to received syntax information and use the interpolation filters to produce predictive blocks.

Motion compensation unit 4502 may use some of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter coded block, and other information to decode the encoded video sequence.

Intra prediction unit 4503 may use intra prediction modes for example received in the bitstream to form a prediction block from spatially adjacent blocks. Inverse quantization unit 4504 inverse quantizes, i.e., de-quantizes, the quantized video block coefficients provided in the bitstream and decoded by entropy decoding unit 4501. Inverse transform unit 4505 applies an inverse transform.

Reconstruction unit 4506 may sum the residual blocks with the corresponding prediction blocks generated by motion compensation unit 4502 or intra prediction unit 4503 to form decoded blocks. If desired, a deblocking filter may also be applied to filter the decoded blocks in order to remove blockiness artifacts. The decoded video blocks are then stored in buffer 4507, which provides reference blocks for subsequent motion compensation/intra prediction and also produces decoded video for presentation on a display device.

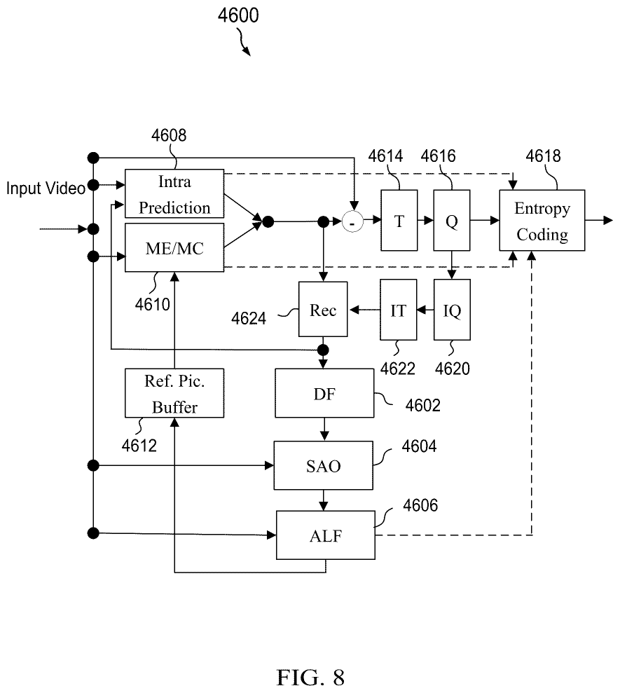

FIG. 8 is a schematic diagram of an example encoder 4600. The encoder 4600 is suitable for implementing the techniques of VVC. The encoder 4600 includes three in-loop filters, namely a deblocking filter (DF) 4602, a sample adaptive offset (SAO) 4604, and an adaptive loop filter (ALF) 4606. Unlike the DF 4602, which uses predefined filters, the SAO 4604 and the ALF 4606 utilize the original samples of the current picture to reduce the mean square errors between the original samples and the reconstructed samples by adding an offset and by applying a finite impulse response (FIR) filter, respectively, with coded side information signalling the offsets and filter coefficients. The ALF 4606 is located at the last processing stage of each picture and can be regarded as a tool trying to catch and fix artifacts created by the previous stages.

The encoder 4600 further includes an intra prediction component 4608 and a motion estimation/compensation (ME/MC) component 4610 configured to receive input video. The intra prediction component 4608 is configured to perform intra prediction, while the ME/MC component 4610 is configured to utilize reference pictures obtained from a reference picture buffer 4612 to perform inter prediction. Residual blocks from inter prediction or intra prediction are fed into a transform (T) component 4614 and a quantization (Q) component 4616 to generate quantized residual transform coefficients, which are fed into an entropy coding component 4618. The entropy coding component 4618 entropy codes the prediction results and the quantized transform coefficients and transmits the same toward a video decoder (not shown). Quantization components output from the quantization component 4616 may be fed into an inverse quantization (IQ) components 4620, an inverse transform component 4622, and a reconstruction (REC) component 4624. The REC component 4624 is able to output images to the DF 4602, the SAO 4604, and the ALF 4606 for filtering prior to those images being stored in the reference picture buffer 4612.

A listing of solutions preferred by some examples is provided next.

The following solutions show examples of embodiments discussed herein.

1. A method for processing media data comprising: determining to scale an alternating current (AC) value to derive an inter prediction mode in region-adaptive hierarchical transform (RAHT); and performing a conversion between a visual media data and a visual media data file based on the inter prediction mode.

2. The method of solution 1, wherein the scaling is performed according to:

$${AC}_{predictedinter} = α {AC}_{reference}$$

where AC_{predictedinter} is a scaled AC value, α is a scaling factor, and AC_{reference} is an unscaled AC value.

3. The method of any of solutions 1-2, wherein AC_{reference} is a sum of an attribute space domain, a coefficient in a RAHT domain, a value derived from a corresponding node in a reference frame, a value derived from a corresponding node after motion compensation, a value derived by interpolating at a position in the reference frame, or combinations thereof.

4. The method of any of solutions 1-3, wherein the scaling is applied to a subset of RAHT layers according to one or more of the following: the subset of layers depends on layers that apply inter-prediction, the scaling is applied to a first N RAHT layers, where N is a pre-defined value, a derived value, or a signalled value, the scaling is applied to a last N RAHT layers, where N is a pre-defined value, a derived value, or a signalled value, flags are signalled per layer that use inter-prediction to indicate usage of scaling factors, the subset is pre-defined, or different subsets are used depending on attribute channel, frame or group of pictures, quantization parameters (QPs), or combinations thereof.

5. The method of any of solutions 1-4, wherein scaling is enabled for only some regions of a point cloud, wherein scaling is enabled for only regions with motion values relative to a threshold, and wherein the threshold is pre-defined or signalled in the bitstream.

6. The method of any of solutions 1-5, wherein the scaling is enabled for inter-prediction based on a direct current (DC) value of a current node and a DC value of a reference node, wherein the scaling is enabled only when a ratio of the DC values of the current node and the reference node are meet a threshold condition, and wherein the threshold is pre-defined or signalled in the bitstream.

7. The method of any of solutions 1-6, wherein the scaling value includes one or a set of values and: is different for different RAHT layers, different attribute channels, different QPs, different frames or group of pictures, or a subset of nodes within an octree layer share a same scaling factor or a same set of scaling factors.

8. The method of any of solutions 1-7, wherein scaling is before application of the RAHT transform.

9. The method of any of solutions 1-8, wherein scaling is applied after the RAHT transform, and wherein: a is different for different sub-bands, or a is different for different frequencies in a RAHT layer, which are indicated by {LLH, LHL, HLL, HHL, HLH, LHH, HHH}, wherein LLH, LHL, HLL, HHL, HLH, LHH, HHH have different as or a subset of LLH, LHL, HLL, HHL, HLH, LHH, HHH share a value of α.

10. The method of any of solutions 1-9, wherein α is determined according to one or more of the following: a fixed α or a fixed set of αs are used; α is determined and signalled in the bitstream, and where α is selected from a set of predetermined values or estimated based on a least square minimization per octree layer or per region and quantized; α is estimated based reconstructed neighbors by performing least squares estimation utilizing reconstructed neighbors and reference samples as the training samples or as a linear combination of scaling factors of a last K coded RAHT nodes or K nearest neighboring nodes; α is derived from geometric differences between a current node and reference node, where α decays exponentially as a geometric difference; when a reference frame is also inter-predicted, values of α are inherited from the reference frame; values of a are inherited from the spatial neighbors; or a DC value of a parent and a DC value of a reference node are utilized to determine the scaling value for AC prediction, where α for AC prediction is a ratio of the parent DC value and reference DC value.

11. The method of any of solutions 1-10, wherein usage depends on global motion or local motion of a current frame according to one or more of the following: the scaled prediction is used only when motion is greater than a threshold that is redefined or signalled; different sets of α are used depending on motion relative to a threshold that is redefined or signalled; or a number of layers that employ scaled prediction depends on global motion such that a number of layers increases as global motion increases.

12. The method of any of solutions 1-11, wherein different regions of point clouds use different scaling factors such that regions are defined based on criterions.

13. The method of any of solutions 1-12, wherein inter-prediction involves multiple reference frames, and wherein the scaling is performed according to:

$${AC}_{predictedinter} = {α}_{1} {AC}_{ref 1} + {α}_{1} {AC}_{ref 2} + … + {α}_{F} {AC}_{refF}$$

where AC_{predictedinter} is a scaled AC value for inter prediction, α₁ through α_{F} are scaling factors, and AC_{ref1} through AC_{refF} is are unscaled AC reference values.

14. The method of any of solutions 1-13, wherein intra-predicted samples in the RAHT layers that use AC inter-prediction are scaled, and wherein determination and usage of the scaling factor depends on inter prediction factors and intra-predicted samples have different scaling factors than inter-predicted samples.

15. The method of any of solutions 1-14, wherein the DC value is scaled when the DC value is not inherited from a parent such that a scaled prediction is described by:

$${DC}_{predictedinter} = α {DC}_{reference}$$

where DC_{predictedinter} is a scaled DC value, α is a scaling factor, and DC_{reference} is an unscaled DC value and where determination and usage of the scaling factor depends on AC scaled prediction factors.

16. The method of any of solutions 1-15, wherein usage is signalled in the bitstream in a frame, tile, slice, octree, or combinations thereof.

17. The method of any of solutions 1-16, wherein usage is dependent on coded information including dimensions, color format, color component, slice type, picture type, or combinations thereof.

18. An apparatus for processing video data comprising: a processor; and a non-transitory memory with instructions thereon, wherein the instructions upon execution by the processor, cause the processor to perform the method of any of solutions 1-17.

19. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-17.

20. A non-transitory computer-readable recording medium storing a bitstream of a video which is generated by a method performed by a video processing apparatus, wherein the method comprises: determining to scale an alternating current (AC) value to derive an inter prediction mode in region-adaptive hierarchical transform (RAHT); and generating a bitstream based on the determining.

21 A method for storing bitstream of a video comprising: determining to scale an alternating current (AC) value to derive an inter prediction mode in region-adaptive hierarchical transform (RAHT); generating a bitstream based on the determining; and storing the bitstream in a non-transitory computer-readable recording medium.

22. A method, apparatus or system described in the present disclosure.

In the solutions described herein, an encoder may conform to the format rule by producing a coded representation according to the format rule. In the solutions described herein, a decoder may use the format rule to parse syntax elements in the coded representation with the knowledge of presence and absence of syntax elements according to the format rule to produce decoded video.

In the present disclosure, the term “video processing” may refer to video encoding, video decoding, video compression or video decompression. For example, video compression algorithms may be applied during conversion from pixel representation of a video to a corresponding bitstream representation or vice versa. The bitstream representation of a current video block may, for example, correspond to bits that are either co-located or spread in different places within the bitstream, as is defined by the syntax. For example, a macroblock may be encoded in terms of transformed and coded error residual values and also using bits in headers and other fields in the bitstream. Furthermore, during conversion, a decoder may parse a bitstream with the knowledge that some fields may be present, or absent, based on the determination, as is described in the above solutions. Similarly, an encoder may determine that certain syntax fields are or are not to be included and generate the coded representation accordingly by including or excluding the syntax fields from the coded representation.

The disclosed and other solutions, examples, embodiments, modules and the functional operations described in this disclosure can be implemented in digital electronic circuitry, or in computer software, firmware, or hardware, including the structures disclosed in this disclosure and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform functions by operating on input data and generating output. The processes and logic flows can also be performed by, and apparatus can also be implemented as, special purpose logic circuitry, e.g., a field-programmable gate array (FPGA) or an application-specific integrated circuit (ASIC).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto optical disks; and compact disc read-only memory (CD ROM) and Digital versatile disc-read only memory (DVD-ROM) disks. The processor and the memory can be supplemented by, or incorporated in, special purpose logic circuitry.

While the present disclosure contains many specifics, these should not be construed as limitations on the scope of any subject matter or of what may be claimed, but rather as descriptions of features that may be specific to particular embodiments of the present disclosure. Certain features that are described in the present disclosure in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

Only a few implementations and examples are described and other implementations, enhancements and variations can be made based on what is described and illustrated in the present disclosure.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled may be directly connected or may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for processing media data, comprising:
determining to perform filtering on an alternating current (AC) value to derive an inter prediction block in region-adaptive hierarchical transform (RAHT); and
performing a conversion between a visual media data and a visual media data file based on the determining.

2. The method of claim 1, wherein the filtering is performed according to:
$${AC}_{predictedinter} = α * {AC}_{reference}$$
where AC_{predictedinter} is a filtered AC value, a is a filtering factor, and AC_{reference} is an unfiltered AC value.

3. The method of claim 2, wherein AC_{reference} is derived from a sum of attributes space domain when inter-prediction is applied in an attribute space domain, or
wherein AC_{reference} is obtained in a transform domain.

4. The method of claim 2, wherein AC_{reference} is a value derived from a corresponding reference block in a reference frame, a value derived from a corresponding reference block after motion compensation, a value derived by interpolating at a position in the reference frame, or a combination thereof.

5. The method of claim 1, wherein the filtering is applied to a subset of RAHT layers,
wherein the subset of RAHT layers depends on RAHT layers that apply inter-prediction,
wherein the filtering is applied to a last M RAHT layers, where M is a signalled value, a pre-defined value, or a derived value, or
wherein for the subset of RAHT layers, flags are signalled per layer that use inter-prediction, and the flags indicate usage of filtering factors.

6. The method of claim 1, wherein the filtering is applied to a first N RAHT layers, where N is a signalled value, a pre-defined value, or a derived value,
wherein the filtering is applied to a subset of RAHT layers, and the subset of RAHT layers is pre-defined, or
wherein different subsets of RAHT layers are used depending on attribute channel, frame or group of pictures, quantization parameters (QPs), or a combination thereof.

7. The method of claim 1, wherein the filtering is enabled for only some regions of a point cloud,
wherein the filtering is enabled for only regions with motion values greater than or less than a first threshold value that is pre-defined or signalled in a bitstream comprising the visual media data file,
wherein whether the filtering is enabled for inter-prediction is based on a direct current (DC) value of a current node and a DC value of a reference node, or
wherein the filtering is enabled only when a ratio of the DC value of the current node to the DC value of the reference node meets a threshold condition based on a second threshold value that is pre-defined or signalled in a bitstream comprising the visual media data file.

8. The method of claim 2, wherein the filtering factor includes one value or a set of values,
wherein the filtering factor is allowed to be different for different RAHT layers, for different attribute channels, for different quantization parameters (QPs), or for different frames or groups of pictures, or
wherein a subset of nodes within an octree layer share a same filtering factor or a same set of filtering factors.

9. The method of claim 1, wherein the filtering is applied in an attribute space domain.

10. The method of claim 2, wherein the filtering is applied after RAHT transform, and
wherein α is different for different sub-bands, or a is different for different frequencies in a RAHT layer, which are indicated by {LLH, LHL, HLL, HHL, HLH, LHH, HHH}, wherein LLH, LHL, HLL, HHL, HLH, LHH, HHH have different filtering factors, respectively, or a subset of {LLH, LHL, HLL, HHL, HLH, LHH, HHH} share a value of α.

11. The method of claim 2, wherein α is determined according to one or more of following:
a fixed α or a fixed set of values of α is used;
α is determined and signalled in a bitstream comprising the visual media data file, where α is selected from a set of predetermined values and signalled, or α is estimated based on a least square minimization per octree layer or per region, quantized, and signalled;
α is estimated based on reconstructed neighbors by performing least squares estimation utilizing the reconstructed neighbors and reference samples of the reconstructed neighbors as training samples, or α is a linear combination of filtering factors of last K coded RAHT nodes or K nearest neighboring nodes, wherein K is an integer;
α is derived from geometric differences between a current node and a reference node, where α decays exponentially as a function of geometric difference;
when a reference frame is also inter-predicted, a value of α is inherited from the reference frame;
a value of α is inherited from spatial neighbors; or
a DC value of a parent node and a DC value of a reference node are utilized to determine the filtering for AC prediction, where α for AC prediction is a ratio of the DC value of the parent node to the DC value of the reference node.

12. The method of claim 2, wherein a usage of the method depends on global motion or local motion of a current frame,
wherein AC_{predictedinter} is used only when the global motion or the local motion of the current frame is greater than a threshold that is pre-defined or signalled,
wherein different sets of α are used depending on a comparison between the global motion or the local motion of the current frame and a threshold that is pre-defined or signalled,
wherein a number of layers that employ AC_{predictedinter} depends on the global motion of the current frame such that the number of layers increases as the global motion increases, or
wherein different regions of point clouds use different filtering factors, and wherein the different regions are defined based on criteria including motion, texture, or a combination thereof.

13. The method of claim 1, wherein inter-prediction involves multiple reference frames, and wherein the filtering is performed according to:
$${AC}_{predictedinter} = {α}_{1} * {AC}_{ref 1} + {α}_{2} * {AC}_{ref 2} + … + {α}_{F} * {AC}_{refF}$$
where AC_{predictedinter} is a filtered AC value for the inter-prediction, α₁ through α_{F} are filtering factors, AC_{ref1} through AC_{refF} are unfiltered AC reference values, and F is a number of the multiple reference frames.

14. The method of claim 1, wherein intra-predicted samples in RAHT layers that use AC inter-prediction are filtered, wherein determination and usage of a filtering factor for the intra-predicted samples depends on similar factors as inter-prediction, and wherein the intra-predicted samples have different filtering factors than inter-predicted samples, or
wherein a direct current (DC) value is filtered when the DC value is not inherited from a parent node, and the filtering for the DC value is performed according to:
$${DC}_{predictedinter} = β * {DC}_{reference}$$
where DC_{predictedinter} is a filtered DC value, β is a filtering factor, and DC_{reference} is an unfiltered DC value, and where determination and usage of the filtering factor β depends on similar factors as AC filtered prediction.

15. The method of claim 1, wherein usage of the method is signalled in a bitstream comprising the visual media data file, wherein the usage of the method is signalled in a frame level, tile level, slice level, octree level, or a combination thereof, or
wherein usage of the method is dependent on coded information including dimensions, color format, color component, slice type, picture type, or a combination thereof.

16. The method of claim 1, wherein the conversion comprises encoding the visual media data into the visual media data file.

17. The method of claim 1, wherein the conversion comprises decoding the visual media data from the visual media data file.

18. An apparatus for processing media data, comprising: a processor; and a non-transitory memory with instructions thereon, wherein the instructions upon execution by the processor, cause the processor to:
determine to perform filtering on an alternating current (AC) value to derive an inter prediction block in region-adaptive hierarchical transform (RAHT); and
perform a conversion between a visual media data and a visual media data file based on the determination.

19. A non-transitory computer-readable storage medium storing instructions that cause a processor to:
determine to perform filtering on an alternating current (AC) value to derive an inter prediction block in region-adaptive hierarchical transform (RAHT); and
perform a conversion between a visual media data and a visual media data file based on the determination.

20. A non-transitory computer-readable recording medium storing a bitstream of a media data which is generated by a method performed by a media data processing apparatus, wherein the method comprises:
determining to perform filtering on an alternating current (AC) value to derive an inter prediction block in region-adaptive hierarchical transform (RAHT); and
generating a visual media data file based on the determining.
